(19) United States
(12) Patent Application Publication
(10) Pub. No.: US 2026/0016338 A1
(43) Pub. Date: Jan. 15, 2026

(54) LONG-RANGE FLAME DETECTION SYSTEM

(71) Applicant: OPTECT LTD, Bath (GB)

(72) Inventors: Matthias JÄGER, Berlin (DE); Alexander Pallister James HUDSON, Bath (GB)

(21) Appl. No.: 18/870,054

(22) PCT Filed: Jun. 16, 2023
(86) PCT No.: PCT/GB2023/051591

§ 371 Date: Nov. 27, 2024

(30) Foreign Application Priority Data
Jun. 17, 2022 (GB) 2208915.5

(51) Int. Cl. G01J 5/00; G01J 5/08; G01J 5/34

(52) U.S. Cl. CPC G01J 5/0018; G01J 5/08; G01J 5/34

(57) ABSTRACT

A flame detector including: a plurality of detectors; a plurality of filters; a plurality of non-imaging optical concentrators having an entrance arranged to receive light incident on the flame detector and an exit arranged to deliver the light to a coupled detector. A first of the plurality of filters transmits light of a first wavelength range to a first of the detectors, and a second of the plurality of filters transmits light of a second wavelength range to a second of the detectors, wherein the second wavelength range is different from the first wavelength range.

### FIELD

The present disclosure concerns a long-range flame detection device. More particularly, this disclosure concerns a system comprising a non-imaging optical concentrator configured to focus light of different wavelengths on a plurality of pyroelectric detectors for flame detection, for example wild-fire detection. The disclosure also concerns a method of detecting a fire using the flame detector.

### BACKGROUND

Current flame detection systems typically use detectors that are sensitive to ultraviolet light (UV), infra-red light (IR) or a combination of both. Pyroelectric infra-red detectors (PIR) have been used in IR flame detectors for many years.

Pyroelectric detectors use a material in which temperature changes generate a current. Because light will increase the temperature of the material, pyroelectric detectors can be used for the detection of fires and other light sources. Pyroelectric detectors can work for a wide range of wavelengths, from UV to deep IR and beyond. Their sensitivity is typically much lower compared to detectors that use semiconductors to detect the light but, at the wavelength relevant for flame detection, equivalent semiconductor devices, which are made using uncommon materials and need cooling, are very expensive to source and operate.

Pyroelectric detectors have a band-pass characteristic: they do not respond to a change in temperature that is slower than a minimum rate (thus they do not respond to a constant temperature) nor to a change that is faster than a maximum rate. If the rate of change is faster than the maximum, the resultant signal will be averaged. A typical pyroelectric detector has maximum response at 3 or 4 Hz. Pyroelectric detectors may be less sensitive to signals at lower or higher frequencies but can still detect signals with frequencies from 0.1 Hz up to 100 Hz, or even 1 kHz. In pyroelectric flame detectors, the flickering of the flames provides the varying temperature that make the signal detectable. Flame flickering may provide strong signals in the frequency region between 1 Hz and 20 Hz.

Clearly, there is a need for early detection of flames and fires. Flame detection systems can be configured to detect fires at different ranges i.e. different distances from the flame detector system to the fire. Indoor fire detection systems typically have a detection range of 10 m to 40 m. Current outdoor detection systems can have a detection range of 30 m to 120 m but that is still not long enough to reliably detect fires in some situations. At these ranges, fires, for example wild-fires, may have spread significantly before they are detected, so it may be too late to prevent the fires from causing devastating damage to communities and to people's lives. For example, electricity power distribution lines can extend for tens or even hundreds of kilometres over land that is vulnerable to wildfires. Many of the most damaging fires are sparked-off by power-line failure. These often occur in remote, difficult-to-access terrain and have led to huge claims on utility providers for consequential damages. Early intervention is key to damage control, but current fire-detection technologies (for example thermal imaging, satellites, human firewatchers) have severe cost, time-delay and practicality issues that limit deployment. It would be desirable to detect wildfires arising from electricity distribution lines whilst reducing or eliminating those problems.

Waveguides, for example optical fibres and light pipes, for directing electromagnetic radiation (EMR) onto a receiver, detector or sensor have been known for many years. A compound parabolic concentrator (CPC) is an example of a non-imaging concentrator. CPCs accept incoming radiation over a relatively wide range of angles. An advantage of a reflective CPC is that it concentrates all wavelengths of electromagnetic radiation (EMR) and can thus be used to collect radiation from broadband sources of radiation. FIG. 1 shows an example of a CPC having a central portion 8 comprising sides 4 which are, in cross-section, segments of a parabola, disposed between an entrance 12 and an exit 6.

CPCs have been used in combination with pyroelectric infrared detectors, for example in US patent application US 2002/0081760A1, which discloses a method for improving the performance of PIR detectors by combining an array of micro-machined radiation collectors, for example CPCs, with thin film pyroelectric detectors which are in contact with an exit of the CPCs. However, manufacturing and coupling CPCs with thin film pyroelectric detectors can be difficult. Furthermore, as a pyroelectric detector detects changes in temperature, thermal loses in such arrangements can be problematic.

The present disclosure seeks to mitigate the above-mentioned problems. Alternatively or additionally, the present invention seeks to provide an improved fire detector and a method of optimising for long-range detection.

### SUMMARY

According to a first aspect of the present disclosure there is provided a long-range flame detector, having the features set out in claim 1 below.

According to a second aspect of the present disclosure, there is provided a method of detecting a fire using a long-range fire detector having the steps set out in claim 32 below.

Preferred, but optional, features of the present disclosure are set out below and in the dependent claims.

It will of course be appreciated that features described in relation to one aspect of the present disclosure may be incorporated into other aspects. For example, any of the methods of the disclosure may incorporate any of the features described with reference to the apparatus of the disclosure and vice versa.

### DESCRIPTION OF THE DRAWINGS

Embodiments of the present invention will now be described by way of example only with reference to the accompanying schematic drawings of which:

FIG. 1 shows a schematic side view of an example compound parabolic concentrator, with ray tracing;

FIG. 2 shows cross sectional view of a long-range flame detector in accordance with an example embodiment of the present disclosure;

FIG. 3 shows an exploded perspective view of the components of the long-range flame detector in accordance with the flame detector of FIG. 2;

FIGS. 4a and 4b show a perspective view of a concentrator casing in accordance with the flame detector of FIG. 2;

FIG. 5 shows a flow chart of the method steps of an example method of the disclosure.

FIG. 6 shows a flow chart of the method steps of another example method of the disclosure;

FIG. 7 shows a perspective view of a mounted flame detector in accordance with an example embodiment of the present disclosure;

FIG. 8 shows a cross-sectional view of the mounted flame detector shows of FIG. 7, in a vertical plane along the centre line of the detector;

FIG. 9 shows a perspective view of a flame detector connected to a solar panel, in accordance with an example embodiment of the present disclosure;

FIG. 10 shows a plot of the example geographical locations of the installed flame detectors;

FIG. 11 shows an example of a power line on which the flame detectors are installed; and

FIG. 12 shows a plan view of a warehouse with a plurality of flame detectors in accordance with an example embodiment of the present disclosure.

### DETAILED DESCRIPTION

In a first aspect, this disclosure provides a flame detector comprising: a plurality of detectors; a plurality of filters; a plurality of non-imaging optical concentrators having an entrance arranged to receive light incident on the flame detector and an exit arranged to deliver the light to a coupled detector; and wherein a first of the plurality of filters transmits light of a first wavelength range to a first of the detectors, and a second of the plurality of filters transmits light of a second wavelength range to a second of the detectors, wherein the second wavelength range is different from the first wavelength range.

As used herein, the term “light” is used to refer to electromagnetic radiation of any IR, visible or UV wavelength.

The detectors may be pyroelectric detectors.

The flame detector of the present disclosure may be a long-range flame detector for outdoor fire detection, for example wild-fire detection. As discussed above, existing outdoor pyroelectric flame detection devices typically detect fires at ranges of 30 to 120 m. The flame detector of the present disclosure may be configured to detect fires at a range of around 900 m. For example, the flame detector may be able to detect fires at ranges between 80 m and 2,000 m. Thus, a detector of the present disclosure may be considered a “long-range” flame detector. It will be appreciated that the fire detector of some embodiments of the present disclosure may be configured to detect fires at shorter ranges, for example at ranges 30 to 120 m.

Optical concentrators collect more light from some directions, at the price of less light being connected from other directions. The field of view (FoV) of the optical concentrator may be in the range of 5 degrees to 60 degrees in a horizontal direction. The field of view of the optical concentrator may be in the range of 5 degrees to 60 degrees in a vertical direction. A field of view of 16 degrees by 16 degrees enables the range over which flames can be detected to be increased approximately 10-fold compared with the range of a half-sphere (180 degrees by 180 degrees) field of view.

For the specific applications where linear regions are to be monitored by the flame detector, for example corridors of interest such as straight mine tunnels, aisles in warehouses or powerlines, the range of the detector does not need to be the same in all directions within the field of view. As perspective results in the corridor of interest becoming smaller at longer ranges, most of the area being monitored can be at the centre of the field of view, and so the range can be reduced at the periphery of the field of view, providing greater range along the corridor. To put that another way, horizontally, directions that are further away from the optical axis of the detector will hit the edges of the corridor of interest at a shorter distance than where a wider area is being monitored. This allows for a reduced range towards those edges which, can be traded for a longer range along the centre of the corridor of interest. For example, the range along an axis extending along the centre of the area being monitored may exceed the range at the extreme edges of the area being monitored by more than 10%, more than 20% or even more than 30%. The flame detector may be configured to monitor a corridor of width 20 to 100 m, for example.

For each of the plurality of filters, the filters may block light with a wavelength outside of the wavelength range. For example, the first filter may block light with a (or any) wavelength that is not within the first wavelength range, and the second filter may block light with a (or any) wavelength that is not within the second wavelength range.

Each of the pyroelectric detectors may have a receiving surface comprising a layer of pyroelectric material upon which the light is incident, and wherein the receiving surface of each of the plurality of pyroelectric detectors is outside of the coupled non-imaging optical concentrator and at least 100 μm from the exit of the coupled non-imaging optical concentrator. The receiving surface comprises a layer of pyroelectric material which is a polarised material. When the material is exposed to a change in temperature, the polarisation of the material changes giving rise to an electrical signal. The pyroelectric receiving surface can be sensitive to small thermal changes, for example fluctuations in background radiation or noise from other components. Because the pyroelectric receiving surface of the pyroelectric detectors is at a distance from, and not in contact with, the exit of the non-imaging optical concentrator, it is thermally isolated from the concentrator. The receiving surface may comprise an absorption layer. The absorption layer may be a coating or thin layer of material which may improve the absorption of the incident light. The absorption layer may be a black coating for example a polymer coating with filler materials like carbon black material. The absorption layer may be patterned to improve absorption. The absorption layer may comprise metal materials. The absorption layer may be a black coating in both the visible and IR spectrum.

The pyroelectric receiving surface may be a thin film material. The pyroelectric receiving surface may be a thin film ferroelectric material. An example is a ferroelectric Lead Zirconate Titanate (PZT), which is a piezoelectric ceramic material, deposited on a silicon (Si) wafer.

Separating the pyroelectric receiving surface of the pyroelectric detectors from the exit of the coupled non-imaging optical concentrators reduces or eliminates thermal losses into the optical concentrator. The distance between the pyroelectric receiving surface of the pyroelectric detectors and the exit of the coupled non-imaging optical concentrators is preferably at least 100 μm. Preferably, the distance between the pyroelectric receiving surface of the pyroelectric detectors and the exit of the coupled non-imaging optical concentrator is at least 200 μm. Preferably, the distance between the pyroelectric receiving surface of the pyroelectric detectors and the exit of the coupled non-imaging optical concentrators is at least 500 μm. On the other hand, if the pyroelectric receiving surface is too far from the exit then light that leaves the concentrator may be lost. For example, light at otherwise possible angles of incident may not reach the receiving surface. In other examples, the distance between the pyroelectric receiving surface of the pyroelectric detectors and the exit of the coupled non-imaging optical concentrators may be between 500 μm and 2000 μm (2 mm). Preferably, the pyroelectric receiving surface of the pyroelectric detectors is thermally isolated from other electronic sources which may otherwise act as a heat sink.

The plurality of filters may be positioned between the exits of the non-imaging optical concentrators and the detectors. The filters may be positioned at or in the same plane as the exits of the non-imaging optical concentrators. The filters may be positioned in front of the entrances of the non-imaging optical concentrators. The skilled person will appreciate that “in front” means that light passes through the optical filter prior to passing through the non-imaging optical concentrator. The filters may be positioned inside the non-imaging optical concentrators. The filters may be band-pass filters configured to allow light of a specific range of wavelengths to pass through. The filters may be long-pass filters configured to allow light of wavelengths which are above a cut-off wavelength. The filters may be short-pass filters configured to allow light of wavelengths which are below a cut-off wavelength. Each of the plurality of pyroelectric detectors may have an independent filter, wherein each filter is configured to transmit a specific wavelength range. For example, a filter for a first pyroelectric detector may be configured to transmit a wavelength range of between 4.1 and 4.8 μm, corresponding to hot CO and/or CO2 gases. Hot CO2 has emission bands at wavelengths of 4.3, 9.4, 10.4 and 15 μm. The emission band at 4.3 μm may be the easiest to distinguish as it corresponds to the highest thermal temperature. A filter for a second pyroelectric detector may be configured to transmit a wavelength range of between 5.0-10.0 μm corresponding to human or animal movement. In the present example, the first pyroelectric detector and its corresponding filter may be a “flame detecting” channel. The second pyroelectric detector and its corresponding filter may be a “rejection” channel. The received signal at the flame channel and the rejection channel may be compared with a pre-determined constant. If the received signal is greater than a pre-determined constant, then the flame detector may issue an alert that a fire is detected.

Each of the plurality of pyroelectric detectors may include a casing. Commercially available pyroelectric detectors typically include a casing or protective packaging, with the pyroelectric receiving surface enclosed within the casing. For example the pyroelectric detectors may be packaged in TO-cans, each of which is a hermetically sealed protective casing with a window on a receiving end. The protective casing may have a flat top surface on the receiving end and a hollow cylindrical body. The flat top surface may comprise a window. The window may be circular, rectangular or rectangular with rounded of corners. The window may have a diameter of 0.5 mm. The window may be made of silicon. The refractive index of the silicon window is higher than the refractive index of air, which can significantly impact the transmission of the light to the receiving surface of the pyroelectric detector. The window may comprise one of the plurality of filters configured to transmit light of a specific wavelength range. The flat top surface may be positioned in contact with the exit of the non-imaging optical concentrator. The casing limits the proximity of the receiving surface of the pyroelectric detectors to the exit of the non-imaging optical concentrator. The receiving surface of the pyroelectric detectors will then be located away from, and not in contact with, the exit. The volume of the casing may comprise a gas, preferably a low heat conductive gas, for example xenon or helium. In other examples, the volume of the casing may be held under vacuum. It is advantageous to have the components of the pyroelectric detectors surrounded by vacuum or low heat conductive gases to improve thermal isolation of the components and to prevent unwanted background noise being detected by the pyroelectric receiving surface (which can have a piezoelectric response to mechanical changes).

The pyroelectric detectors may be a triple-channel infrared detector (IR-3detector). Commercial IR-3 detectors comprise three pyroelectric detectors, each of which is configured to detect a different range of wavelengths. The IR-3 detectors may comprise a protective casing, for example a TO-can. A filter may be positioned in front of each pyroelectric receiving surface for example embedded in an entrance window of the IR-3 detector. The filter may be configured to transmit light of a specific wavelength range. The first wavelength range of the first filter for a first pyroelectric receiving surface may between 4.1 μm and 4.8 μm. The first wavelength range may provide an indication of hot CO and/or CO2 gases. The second wavelength range of the second filter for a second pyroelectric receiving surface may between 5.0 μm and 10.0 μm. The second wavelength range may provide an indication of human or animal movement. The third wavelength range of the third filter for a third pyroelectric receiving surface may between 3.8 μm and 4.0 μm. The third wavelength range may provide an indication of reflected sunlight or other high temperature signals such as welding arcs. The signals received by the second and third pyroelectric detectors may be rejected by electronic circuitry within the flame detector. The signals received by the second and third pyroelectric detectors may be used by the flame detector to decide whether or not a fire has been detected.

The flame detector may include one or more auxiliary pyroelectric detectors, the auxiliary pyroelectric detectors being arranged to receive light directly from the environment (i.e. not via a concentrator). The auxiliary pyroelectric detector may be not coupled to (i.e. it may be independent from) all non-imaging optical concentrators. There may, for example, be three auxiliary pyroelectric detectors, arranged to detect the wavelength ranges of the first, second and third pyroelectric detectors discussed above, but arranged to receive light not via a concentrator. Auxiliary detectors of that kind have a shorter range but a wider field of view than a detector that receives light via a concentrator. Use of one or two auxiliary detectors, at the wavelength range of the second and/or third detectors discussed above, can improve the detection of signals not resulting from fires, and hence increase the reliability of the flame detector. An auxiliary detector at the wavelength range of the first detector discussed above may be used to cover one or more areas to which the first detector is blind and/or to provide detection of fires at closer ranges than the operating range of the first detector. The auxiliary pyroelectric detectors may comprise the features of the pyroelectric detectors as discussed above.

The auxiliary detectors may be coupled to a non-imaging optical concentrator. The non-imaging optical concentrator may have a shorter range and wider field of view than the other non-imaging optical concentrator used with the first, second and/or third pyroelectric detectors as discussed above.

The auxiliary pyroelectric detectors may comprise a filter configured to transmit light of a specific wavelength range. The filter may be arranged on a flat top surface of a protective casing. The wavelength range may correspond to human and/or animal movement. The wavelength range may be between 5.0 μm and 10.0 μm. In an example where the auxiliary detector is coupled to a non-imaging optical concentrator, the non-imaging optical concentrator of the auxiliary detector may have a shorter range and wider field of view than the non-imaging optical concentrator not of the auxiliary detector. The exit of the non-imaging optical concentrator may comprise the filter.

The auxiliary pyroelectric detectors may be independent from all non-imaging concentrators, as discussed above. An auxiliary detector may comprise at least two auxiliary pyroelectric detectors. The auxiliary detector may comprise at least two auxiliary pyroelectric detectors, each of which is coupled to a non-imaging optical concentrator with a larger field of view than the field of view of the non-imaging optical concentrators of the other (non-auxiliary) detectors.

Other pyroelectric detectors that may be used in the flame detector include UV-IR, UV-IR2 and four-wavelength systems, for example IR3 plus UV or IR3 plus a detector that detects a particular flame detection wavelength, for example the wavelengths associated with hydrogen flames.

At least one of the non-imaging optical concentrators may be a non-imaging radiation-collector (NIRC). NIRC's are compact and low-cost collectors of radiation that typically work across a range of IR wavelengths. NIRC's may work without the need for expensive optical materials such as germanium (Ge).

At least one of the non-imaging optical concentrators may be a compound parabolic concentrator (CPC). Optical concentrators such as CPCs accept light over a relatively wide range of angles. Hence they may allow for a higher concentration of light by providing a wider range of incident angles that can be detected by a detector. The field of view (FoV), or the range of viewing angles, of the CPC varies with the geometry of the CPC. For example, a CPC designed for an 8 degree (full angle) FoV and an output aperture of 1 mm would have a length of 110 mm and an input aperture of 14.3 mm.

At least one of the non-imaging optical concentrators may have a cross-sectional area at each point along the length of the non-imaging optical concentrator that is smaller than the cross-sectional area of a CPC having an exit of the same area as the exit of the non-imaging optical concentrator.

At least one of the non-imaging optical concentrators may have a rectangular cross-section, for example a square cross-section. At least one of the non-imaging optical concentrators may have an entrance and exit with a rectangular cross section and a central portion disposed therebetween, wherein the central portion has a rectangular cross section with four curved side edges, each side edge extending from the entrance to the exit of the optical concentrator. Commercial concentrators, such as CPCs, typically have a central portion disposed between the entrance and exit, and sides which are, in cross section, segments of a parabola; for example, the central portion may be a truncated paraboloid. A CPC of this configuration may have a rotational symmetry with circular entrance and exit apertures.

The cross section of the exit of a non-imaging optical concentrator may match the cross section of the pyroelectric detector. Matching the shape of the exit of the non-imaging optical concentrator to the shape of the pyroelectric detector may ensure that the whole area of the detector is used. The dimensions of the exit of a non-imaging optical concentrator may match the dimensions of the pyroelectric detector. The dimensions of the exit of a non-imaging optical concentrator may be greater than the dimensions of the pyroelectric detector.

At least one of the non-imaging optical concentrators may comprise a hollow central portion disposed between the entrance and exit. Advantageously, this may reduce the amount of materials used and thus reduce the cost of manufacturing compared to a solid non-imaging optical concentrator, for example a dielectric totally internally reflecting concentrator (DTIRC). The central portion may comprise a reflective surface. The reflective surface may comprise metal material, for example steel or aluminium. The metal material may be polished. The reflective material may be applied using a vacuum deposition method. A protective layer may be applied on the reflective material. The protective layer may comprise an inert material, for example SiO2. The protective layer may also be applied using the deposition method described above.

At least one of the non-imaging optical concentrators may be manufactured by injection moulding using plastics material, for example polycarbonate or a similar material. The non-imaging optical concentrator may be manufactured in multiple parts. This may be beneficial for the polishing or deposition of the reflective surfaces.

The entrance of a non-imaging optical concentrator may comprise a window. The window may protect the reflective surface within the hollow central portion from environmental influences. The window may shield the pyroelectric receiving surface of the pyroelectric detectors from air movement. Additionally, the window may act as a filter to prevent far-infrared radiation (wavelengths of greater than around 10 μm) reaching the detectors. The window may comprise an anti-reflection coating for the wavelengths accepted by the filters. The window may be a sapphire window.

At least one of the non-imaging optical concentrators may be fixed in an enclosure. The enclosure may be made of metal material. The enclosure may comprise a window for receiving light for the flame detector. The window of the enclosure may be a filter, for example the window may act as a filter to prevent far-infrared radiation (wavelengths of greater than around 10 μm) reaching the detectors. The window may be a sapphire window. The entrance of the non-imaging optical concentrator may be positioned at the window of the enclosure. The entrance of the non-imaging optical concentrator may be positioned inside the casing and at a distance away from the window of the enclosure, which may improve the thermal isolation of the window and/or the non-imaging optical concentrator. Such an arrangement may allow the heating of the window with less power than in other, less thermally isolated arrangements. The window may protect the non-imaging optical concentrator from environmental effects.

In the flame detector of the present disclosure there may be at least three independent pyroelectric detectors. The three pyroelectric detectors may be aligned i.e. the pyroelectric receiving surfaces may be aligned on the same plane with their viewing axes parallel. The present disclosure is not limited to three detectors. In some examples, there may be a greater number of detectors, for example four, five or six detectors.

The pyroelectric detectors may be mounted on a printed circuit board (PCB). The PCB may be connected to an external device, for example a computer, laptop, phone or tablet. The PCB may process the electric signal generated by the receiving surface of the pyroelectric detector. The PCB may comprise an amplifier. The electric signal may be processed to generate an alarm signal, which may be provided over a wired or wireless connection; for example, the alarm signal may be provided over a mesh network. The alarm signal may be sent to a user via the internet, for example on a cloud based service.

The pyroelectric detectors may comprise a connection point which is used to mount the pyroelectric detector on the PCB. The connection point may be used to accurately align the pyroelectric detectors with the exit of the non-imaging optical concentrators. The flame detector may comprise more than one PCB. The flame detector may comprise a second PCB which includes a microcontroller for analysing the received signal. The flame detector may comprise a third PCB which is for testing. For example, a third PCB may be connected to an auxiliary pyroelectric detector.

The flame detector may comprise a layer of insulating material between the pyroelectric detectors and the PCB. The insulating layer may be a foam layer. The foam layer may apply a pressure to keep the protective casing of the pyroelectric detector fixed tightly with the exit of the coupled non-imaging optical concentrator. For example, the protective casing of the pyroelectric detectors may be positioned to within 0.1 mm of the exit of the coupled non-imaging optical concentrator. Preferably, the protective casing of the pyroelectric detectors may be aligned to within 0.05 mm of the exit of the coupled non-imaging optical concentrator. The insulating layer may prevent air movement close to the pyroelectric detectors. The insulating layer may improve the isolation of the pyroelectric detectors.

The flame detector comprises a plurality of non-imaging optical concentrators (for example, the flame detector may comprise three non-imaging optical concentrators and three detectors). Each non-imaging optical concentrator may be configured to direct light to a pyroelectric receiving surface of one of the pyroelectric detectors. The plurality of non-imaging optical concentrators may be aligned next to each other. In some example embodiments, the non-imaging optical concentrators are configured such that at least two of the concentrator are positioned at a non-zero angle with the viewing axis of the concentrators. Positioning the non-imaging optical concentrators at an angle may increase the range of the detector. In another example, three non-imaging concentrators may be coupled to one pyroelectric detector, for example an IR-3 detector. The IR-3 detector may comprises three pyroelectric receiving surfaces within its casing.

The flame detector according to the present disclosure may be enclosed in a housing. The housing may be made of metal material. The volume of the housing may comprise a gas, preferably a low heat conductive gas, for example xenon or helium. In other examples, the volume of the housing may be held under vacuum

The flame detector may include a microcontroller.

The flame detector may be mounted to an industrial pylon, for example an electricity pylon.

The flame detector may comprise a gimbal. The housing of the flame detector may be coupled to the gimbal. The gimbal may be mounted on a wall, for example within a warehouse. The gimbal may be mounted to an industrial pylon, for example an electricity pylon.

The flame detector may comprise a camera, for example a camera operating at visible wavelengths. The camera may help with adjusting the position of and aligning the flame detector, for example when the flame detector is mounted at height. The camera may be used in conjunction with the pyroelectric detectors to detect fires.

The flame detector may comprise a power supply. The power supply may be an internal battery. The flame detector may comprise an electrical cable which connects to an external power source, for example when the flame detector is mounted in an industrial warehouses. The housing of the flame detector may comprise solar panels, for example when the flame detector is mounted outdoors on a pylon.

The flame detector may comprise a communication module, for example a mesh radio module.

The flame detector may comprise sensors, for example an accelerometer. An accelerometer may be used to detect pylon vibrations when mounted on a pylon. The flame detector may comprise atmospheric sensors. The atmospheric sensors may measure the external atmospheric pressure, temperature, wind speed and/or direction and provide local weather conditions.

The plurality of detectors may comprise a semiconductor material, for example, the detectors may be semiconductor based photodetectors. The semiconductor material may be lead sulfide (PbS). The semiconductor material may be mercury cadmium zinc telluride (HgCdZnTe). Other semiconductor material may also be used, for example cadmium telluride or cadmium zinc telluride.

The semiconductor material may be held at low temperatures, for example at 243 Kelvin. Semiconductor materials may be held at low temperatures to reduce noise from unwanted environmental influences, for example heat from other components within the flame detector. Semiconductor materials may be held at temperatures below 243 Kelvin. In other examples, semiconductor materials may be held at temperatures above 243 Kelvin.

Where aspects of the disclosure have been described in relation to pyroelectric detectors, they may be equally applicable to other detectors, for example detectors comprising semiconductor material, such as photodetectors.

In accordance with another aspect of the disclosure, there is provided a method of aligning a flame detector in accordance with the first aspect of the disclosure comprising the steps of:
a) providing one of the plurality of detectors at the exit of the coupled non-imaging optical concentrator and;
b) sending a calibration signal to the entrance of the non-imaging optical concentrator;
c) measuring the calibration signal at the receiving surface of the detectors;
d) adjusting the detector in at least three dimensions;
e) repeating steps (b) and (c);
f) fixing the detectors at a location where the calibration signal is maximised;
wherein the receiving surface is located away from the exit of the non-imaging optical concentrator.

The calibration signal is a light source. For example a small controllable flame may be used as a calibration light source. In other examples, it may be a heat lamp. When the calibration signal is received by the receiving surface, the signal will be converted into an electrical signal.

The detectors, for example pyrolytic detectors, may be coupled to, or mounted on, a printed circuit board. The electronics on or associated with the printed circuit board may convert the electrical signal into a visual signal, for example an image, or an audible signal, for example a siren. The printed circuit board may be connected to an alarm that provides a signal (for example a visual audible or electronic signal) when a fire is detected.

In step d), the detector may be adjusted along a direction orthogonal to the viewing axis of the concentrator. The detector may be adjusted along a direction parallel to the viewing axis of the concentrator. The detector may be adjusted rotationally around the viewing axis of the concentrator.

The detectors may be commercial pyroelectric detectors with a protective casing. The protective casing of the detectors may be fixed to the exit of the non-imaging optical concentrator.

The method may comprise the step of providing an insulating layer between the detectors and the exit of the non-imaging optical concentrators. The insulating layer may be a foam layer. The foam layer may apply a pressure to keep the protective casing of the detector fixed tightly with the exit of the non-imaging optical concentrator.

The standard, textbook, shape for a concentrator—a compound parabolic concentrator—is not optimal for use in conjunction with a pyroelectric detector, especially a packaged pyroelectric detector. Instead, the inventors have sought to design the shape of the non-imaging optical concentrator by using computer-implemented simulations of the behaviour of light passing into the concentrator and to the pyroelectric material. An example method of designing a non-imaging optical concentrator for a flame detector, comprises the steps of, in a simulation:
a) positioning a detector, for example a pyroelectric detector, at an exit of a first concentrator
b) measuring optical parameters of the truncated concentrator using ray-tracing.

The simulation may be carried out using a ray-tracing program for example Zemax. Other ray-tracing programs or software may be used.

The simulated pyroelectric detector may comprise the features of the pyroelectric detector as disclosed in the first aspect of the present disclosure. The simulated pyroelectric detectors may comprise a perfect absorbing surface. A “perfect absorbing surface” as used herein may be a theoretical material which absorbs all incident light without losses.

The method may comprise the step of providing a simulated light source.

The method of designing the non-imaging optical concentrator may comprise the step of using a numerical optimisation method, for example using a gradient descent function or Bayes optimiser, to adjust the shape of the concentrator. The shape of the concentrator may, for the purpose of optimization, be based on a curve, described and parameterised as a polynomial of sufficiently high degree, for example a polynomial of 8^{th} degree. In other examples, the curved shape of the concentrator may be parameterised as a spline curve which provides a number of discrete points which are interpolated. The parameterisation of the curve may happen in a rotated Cartesian coordinate system.

The optimisation method may use a figure of merit, for example the detection range of the concentrator, its FOV and/or the usable etendue at the pyroelectric detector(s). The figure of merit may relate to the detection range of the concentrator at the centre of its field of view. The figure of merit may relate to the lowest maximum detection range of the concentrator within its FOV. The figure of merit may relate to the maximum length of a corridor covered by the flame detector. The method may include matching the shape of the exit of the concentrator to the shape of the pyroelectric receiving surface of the pyroelectric detector.

The method of designing the non-imaging optical concentrator may further comprise the step of increasing the area of the exit of the non-imaging optical concentrator and re-optimising its shape. This step may improve the FOV without changing the detection range.

In accordance with another aspect of the present disclosure, there is provided a method of detecting a fire using the flame detector in accordance with the first aspect of the present disclosure comprises the steps of:
a) collecting light over a predefined time interval;
b) converting the collected light into an electrical signal;
c) providing a calculated value for the light collected at each detector;
d) comparing the calculated value of the different detectors with reference values;
e) using the comparison to classifying the signal as indicating or not indicating the presence of a fire.

The flame detector may comprise three non-imaging optical concentrators, three filters and three detectors, wherein each non-imaging optical concentrator is arranged to deliver light through a filter configured to transmit light of a specific wavelength range to one of the three detectors. The first channel may be arranged to detect wavelength ranges of between 4.1 μm and 4.8 μm (referred to herein as “Flame Signal”). The second channel may be arranged to detect wavelength ranges of between 5.0 μm and 10.0 μm (referred to herein as “Reference Signal 1”). The third channel may be arranged to detect wavelength ranges of between 3.8 μm and 4.0 μm (referred to herein as “Reference Signal 2”). The step of calculating the comparison value may comprise subtracting “Reference Signal 1” from “Fire Signal” and subtracting “Reference Signal 2” from “Fire Signal”. If the comparison values from both result in a value which is greater than a predetermined constant value, it signifies that a fire is detected.

The light may be collected for a time interval of 5 s. The light may be collected for a time period of 10 s.

For each detector, multiple measurements (e.g. 1024 measurements) may be collected over a pre-determined time (e.g. 5 s) at a specific frequency, (in this case 200 Hz). The data from all the detectors may be collected in an internal microprocessor which is connected to all pyroelectric detectors. The collected light may be converted into an electrical signal by the pyroelectric receiving surface of the pyroelectric detector. The electrical signal may be transferred to a printed circuit board.

The method may include the step of analysing the electrical signal. A Fast Fourier Transform (FFT) may be applied to the signal received at each detector. In other examples, the electrical signal may be transferred to a computer or other electronic device, where an FFT of the signal is applied. Frequencies of interest, as potentially corresponding to the flickering of flames of a fire, may be selected. Some frequencies may be disregarded or rejected. For example, frequencies ranges for human or animal movement may be disregarded. Different weights may be applied to different frequencies. The FFT may be plotted on a graph or chart and shown on a screen or other GUI.

The providing, comparing and using steps may be carried out using a microcontroller, for example.

The method may include the step of providing an alarm signal if the signal is classified as indicating the presence of a fire. The alarm signal may be provided over a wired or wireless connection; for example, the alarm signal may be provided over a mesh network. The mesh network may be formed from a plurality of the flame detectors. For example, the alarm signal may be sent to a user via the internet, or a cloud based service.

It will of course be appreciated that features described in relation to one aspect of the present disclosure may be incorporated into other aspects of the present disclosure. For example, the method may incorporate any of the features described with reference to the apparatus and vice versa.

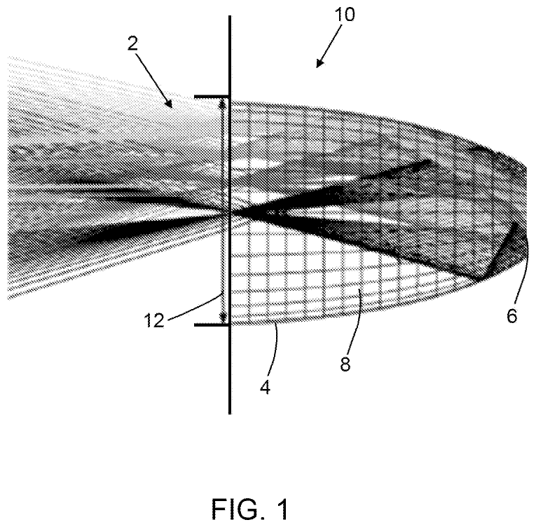

Other example embodiments will now be described in further detail with reference to FIGS. 1 to 12.

FIG. 1 shows a side view of an example compound parabolic concentrator 10 with ray tracing 2 to show examples of the paths taken by incident light. The compound parabolic concentrator 10 has a central portion 8 which has a curved side wall 4 connecting the entrance 12 and the exit 6. The entrance 12 and exit 6 have complementary shapes in the present example: the entrance 12 and exit 6 have a circular cross section, with the diameter of the entrance 12 greater than the diameter of the exit 6. The surface of the sidewall 4 reflects incoming light towards the exit 6.

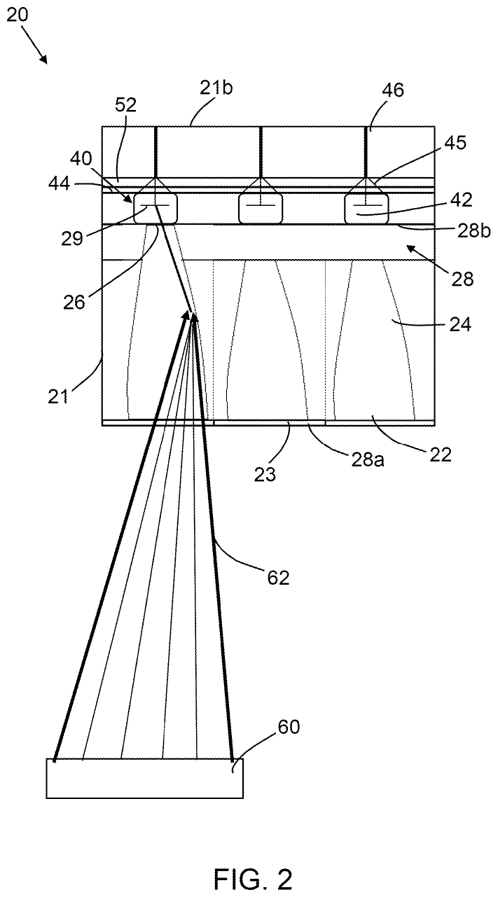

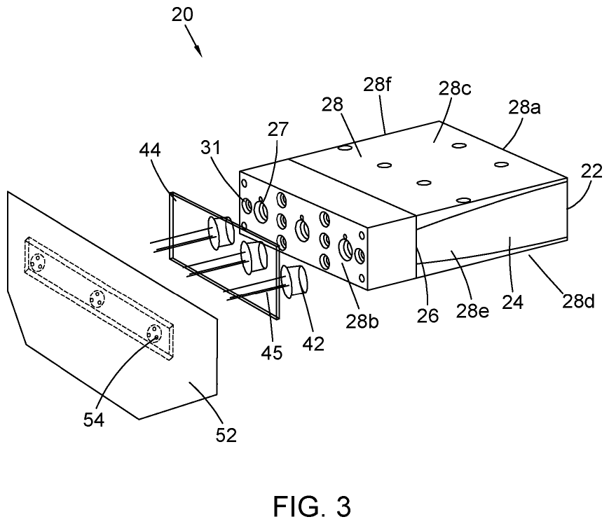

FIG. 2 shows a cross section of an example long-range flame detector 20. The components of the flame detector 20 are in a protective housing 21. The housing 21 of the present example is rectangular and has six surfaces. There are three concentrators 24, each concentrator having an entrance 22 and an exit 26. Three concentrators 24 are arranged parallel to each other with their entrances 22 contained within a first plane and exits 26 contained within a second plane. The concentrators 24 are fixed within a rectangular casing 28, which is described in more detail with reference to FIG. 3 below. The entrances 22 of the concentrators 24 are arranged at a front surface of the housing 21, which is directed towards a target or object 60. Located near the entrance 22 of the concentrator 24 is a window 23. The window 23 is in this example made of sapphire. (Other materials may be used, provided that the window 23 is transparent at the relevant wavelengths.) In the present example, the wavelength ranges of interest are between 3 and 7 μm. There are three separate windows 23, each window configured to fit the cross sectional area of the entrances 22 of each concentrators 24. (In other examples, the front side of the housing 28 may be one window 23.)

The entrance 22 and exit 26 of each concentrator 24 has a rectangular cross section and four elongate side surfaces which form the body of the concentrator. The side surfaces of the concentrator are curved and extend from the entrance 22 and converge to the rectangular exit 26. The concentrators 24 of the present example are hollow. (In other examples the concentrators 24 may be solid, for example, they may comprise a solid central portion which is made of material which is transparent to the relevant wavelengths.)

The concentrators 24 are designed to concentrate light 62 from an object 60, for example a wild fire. The light 62 is received at the entrance 22, is reflected at the sides of the concentrator 24, and directed to the exit 26. The light exits the exit 26 to a detecting region 40. The detecting region 40 is the region which has the highest concentration of light 62 and comprises the pyroelectric detector 42. The pyroelectric detector 42 comprises a protective casing which has a front flat surface that is next to and in contact with the exit 26 of the concentrator 24. The pyroelectric detector 42 comprises a pyroelectric detecting surface 29 which is a thin layer of pyroelectric material. The pyroelectric detecting surface 29 of the pyroelectric detector is positioned at a distance from the exit 26 of the concentrator 24. Thus, the pyroelectric detecting surface is not in contact with the exit 26 of the concentrator 24. At a rear side of the concentrator casing 28, which is near the detecting region 40, there are holes which allows the light 62 to exit the concentrator casing 28 to the detectors 42.

In the present example, three detectors 42 are located at the exit 26 of each concentrator 24. The concentrators 24 are aligned next to each other so that the FOV of each concentrator 24 overlaps. The detectors 42 are single channel pyroelectric detectors, each with a different filter permissive to different wavelengths as part of the protective casing. The combination of the three single channel pyroelectric detectors form an IR-3 detection system. Within the detector casing, the pyroelectric detecting surface 29 is thermally decoupled from its surrounding. In the present example, there is a distance of at least 100 μm between the pyroelectric detecting surface 29 and the exit 26 of the concentrator 24. An example of a protective casing is a TO-through-hole can, made of metal and hermetically sealed to protect the pyroelectric detecting surface 29 from environmental effects such as moisture, contaminants or air movement. Each IR-3 detector 42 comprises a flat top surface with an entrance window which is positioned next to the exit 26 of the concentrator. The entrance window acts as a filter which controls the range of wavelengths that are entered into the body of the TO-can and subsequently the pyroelectric detecting surface 29. The filter of the first pyroelectric detector may be limited to a wavelength range of between 4.1 and 4.8 μm. The wavelength range of the filter of the first pyroelectric detector may corresponds to hot CO and/or CO2 gases. The filter of the second pyroelectric detector may be limited to a wavelength range of between 5.0-10.0 μm. The wavelength range of the filter of the second pyroelectric detector may correspond to human or animal movement. The wavelength range of the filter of the third pyroelectric detector may correspond to reflected sunlight. Other wavelength ranges may be chosen by changing the filters.

The detectors 42 are positioned accurately relative to the concentrators 24 by alignment in three directions: orthogonal to the viewing axis of a concentrator 24, parallel to the viewing axis of the concentrator 24, and rotationally around the viewing axis of the concentrator 24. When the detectors 42 are accurately aligned, they are fixed in position. The exit holes 27 at the rear surface of the concentrator casing 28 are shaped to fit the protective casing of the detectors 42. A foam layer may be provided and configured to apply a gentle pressure on the detectors 42.

The detectors 42 have pins 45 which electrically couple the pyroelectric detecting surface 29 with a printed circuit board (PCB) 52. Once the received light 62 is converted into an electrical signal, cables 46 send the electrical signal to a rear surface of the flame detector housing 21b. The rear surface of the flame detector housing 21b has holes for the cables 46. The cables 46 may be connected to a device including an alarm unit (not shown) mounted on the rear surface of the housing 21b, which sounds an alarm when a fire is detected. (In other examples, the cables 46 may exit the flame detector housing 21 and connect to a PC, tablet or mobile device with a user interface to provide a visual and/or audible signal to indicate a fire is detected.)

Between the rear surface of the concentrator casing 28b and the PCB board 52 there is an absorbing material 44, for example a rubber layer. Advantageously, the absorbing material 44 improves the insulation around the detectors 42 to prevent any background noise, movement or undesirable environmental influences. In some examples, the insulating layer 44 may be a foam layer which is configure to apply a small amount of pressure on the detectors 42 to keep them fitted with the holes at the rear surface of the of the concentrator casing 28b.

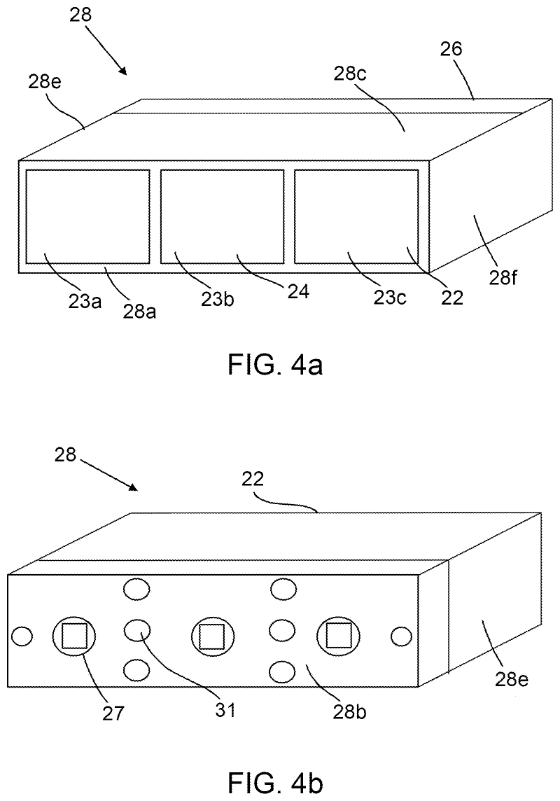

FIG. 3 shows an exploded view of the components of the flame detector 20 of FIG. 2 without the flame detector housing 21. The concentrator casing 28 has six surfaces: front 28a, rear 28b, top 28c, bottom 28d and two sides 28e, 28f. At the front surface 28a, which is shown in FIG. 4a, there are three rectangular openings 23a, 23b, 23c, which have the same cross section as the entrance 22 of each of the concentrators 24.

A concentrator 24 is illustrated through a side surface 28e of the concentrator casing 28 to show the location of the concentrator 24. The concentrator casing 28 may be made of material such as plastics or metal material. In some examples, the concentrators 24 may be integrated in the fire detector housing 21 without a concentrator casing 28. In use, the concentrators 24 would not be visible to the user.

At the rear surface 28b of the concentrator casing 28, there are a plurality of holes 27, 31: eight mounting holes 31, and three exit holes 27. The exit holes 27 align with the exit 26 of the concentrators 24. As described above with reference to FIG. 2, light enters the concentrator 24 at the entrance 22 and exits the exit 26 to a detecting region 40. The detecting region 40 is the region which has the highest concentration of light 62 and comprises the pyroelectric detectors 42. The light is transmitted through the top surface of the protective casing of the detector 42 and to a pyroelectric receiving surface located within the protective casing and at a distance from the exit 26 of the concentrator 24. This configuration ensures that the pyroelectric detecting surface is thermally isolated.

In the present example, three detectors 42 are aligned with the exit holes 27 on the rear surface 28b of the concentrator casing 28.

Each detector has pins 45 extending from the pyroelectric detecting surface(s) towards the PCB 52. In the present example, the PCB has holes 54 for receiving the detector pins 45. The detectors 42 may be attached or embedded to the PCB by soldering pins at the rear of the protective casing (not shown). In other examples, the pyroelectric detector may be fixed to the PCB 52. The PCB includes material (in this example a block of alumina, indicated by dashed lines in FIG. 3), which acts to dampen noise and other vibrations. Noise and other vibrations can be problematic when using pyroelectric detectors as pyroelectric materials are usually also piezoelectric and so can generate electrical signals in response to vibration, which reduces the signal-to-noise ratio of the pyroelectric detectors.

FIGS. 4a and 4b show a perspective view of the concentrator casing 28. FIG. 4a shows the concentrator casing 28 from the front surface 28a with three rectangular openings 23a, 23b, 23c, which have the same cross section as the entrance 22 of the concentrators 24 (in other embodiments, the rectangular openings 23a, 23b, 23c, may have a different shape depending on the shape of the entrance of the concentrator 24.)

FIG. 4b shows the concentrator casing 28 from the rear surface 28b. The rear surface 28b has eight holes 31 which are for fixing the rear end of the concentrators 24 with the rear surface 28b of the concentrator casing 28. There may be more holes for fixing the concentrator casing 28 to other components of the long-range detector, for example to the insulating layer 44 and/or the PCB 52. Additionally, there are three exit holes 27 which are aligned with the exit 26 of each concentrator 24. In use, light is collected at the rectangular openings 23a, 23b, 23c, transmitted through the main body of the concentrators 24, to the exit 26 and exits the concentrator casing 28 via the exit holes 27. The exit holes 27 are also aligned with the top surface of the protective casing of the pyroelectric detectors 42. The pyroelectric detecting surface remains at a distance from the exit 26 of the concentrator 24, and isolated from other electrical components within the flame detector. In the present example, the exit holes 27 are circular. (In other examples they may be a different shape.)

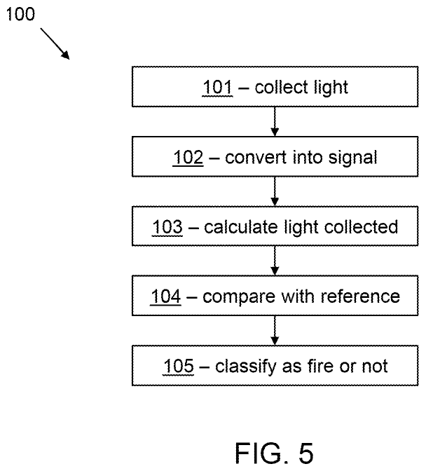

In a method (FIG. 5) of detecting a fire using the flame detector of FIGS. 2 to 4, samples of light are collected (step 101) over a time interval. The collected light samples are converted (step 102) into an electrical signal. A calculated value for the light collected at each detector is provided (step 103). The calculated value at each detector is compared (step 104) with a reference value. The comparison is used to classify (step 105) the signal as indicating a fire or not indicating the presence of a fire.

For example, the following basic algorithm may be used in an example embodiment:
(1) Collect data samples from each detector over a time interval (e.g. 5 s);
(2) Apply a fast fourier transform (FFT) to the data samples of each detector;
(3) Select only the frequencies of interest from the absolute values of the result of the FFT, optionally apply a frequency dependent weight, and sum the values at those frequencies to provide a number for each detector;
(4) Take a weighted difference between numbers for the flame detector and each reference detector (separately);
(5) comparing differences of the calculated values with reference values;
(6) Only classify as a fire if both differences are above a detection limit.

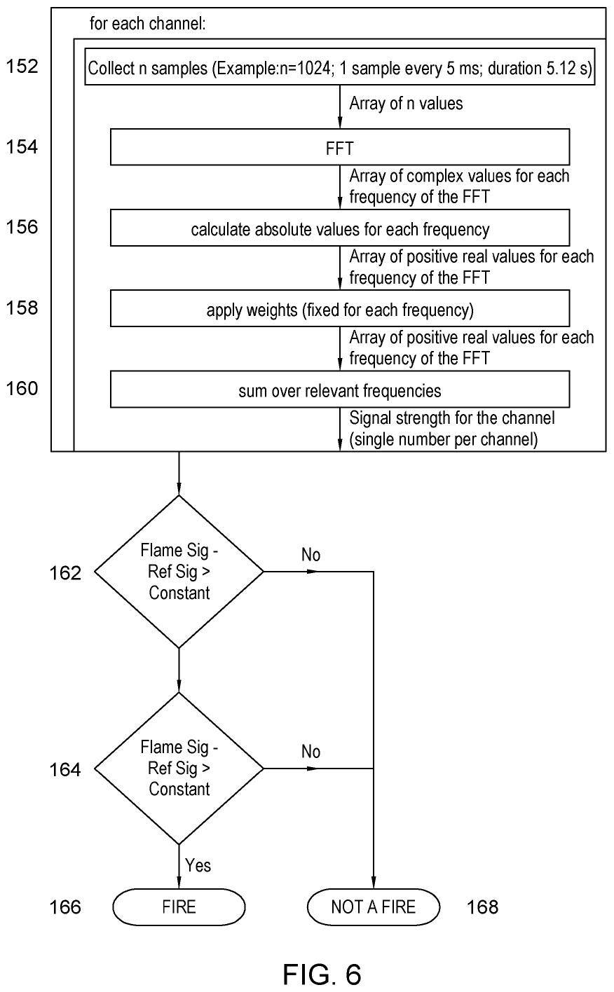

FIG. 6 shows an example method of detecting fires using the flame detector of FIGS. 2 to 4b. In the present example, the flame detector comprises three non-imaging optical concentrators, three filters and three pyroelectric detectors, wherein each non-imaging optical concentrator is arranged to deliver light through a filter configured to transmit light of a specific wavelength range to one of the three pyroelectric detectors. The first pyroelectric detector and its corresponding filter may be a “flame detecting” channel. The second pyroelectric detector and its corresponding filter may be a “reference 1” channel. The third pyroelectric detector and its corresponding filter may be a “reference 2” channel. For each channel, samples of light are collected over a pre-determined time period (step 152). The data is converted into an electrical signal and a fast fourier transform (FFT) is applied to the signal of each detector (step 154). The absolute value for each of the frequencies are calculated (step 156). Thereafter, a weight is applied for each frequency and a weighted difference is calculated between the flame detector and each reference detector (separately) (step 158). A sum of the relevant frequencies is calculated (step 160). The reference signal at each reference channel is separately subtracted from the flame signal of the flame detecting channel and then compared with a pre-determined constant (step 162, step 164). If the comparison value (162, 164) is greater than the pre-determined constant, then the flame detector alerts that a fire is detected (step 166). If the received signal is less than a pre-determined constant, then no alert is set (step 168).

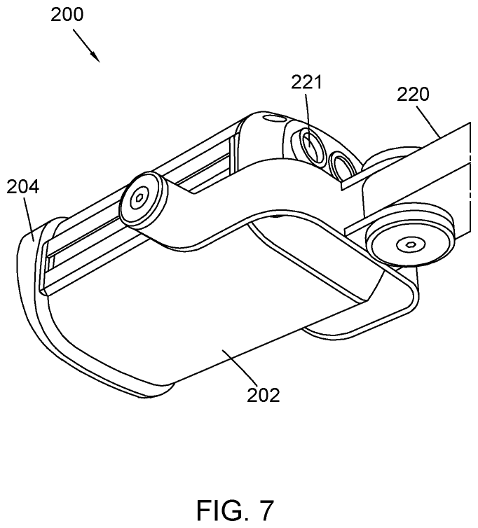

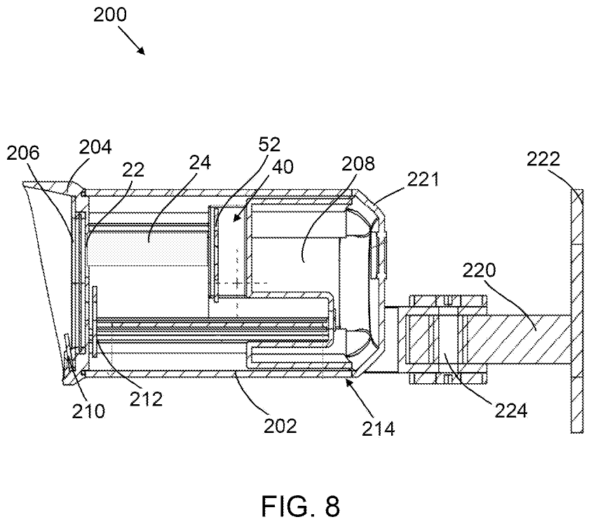

FIG. 7 shows a perspective view of the exterior of a mounted flame detector 200 used for example in industrial areas such as warehouses. FIG. 8 shows a schematic cross-sectional view of the flame detector 200 for mounting on a wall via a mounting plate 222 and arm 220. The mounted flame detector 200 has a protective frame 202 and a front cover 204 which protects the components of the flame detector from environmental influence, for example rain, wind or dust. The arm comprises a pivot 224 which allows the flame detector 200 to move relative to the arm 220 and mounting plate 222. The mounting arm 220 and plate 222 may be a gimbal.

The entrance of the flame detector 200 has a window 206 which is positioned under the front cover 204. The front cover 204 protects the entrance against external influence, such as rain or dust. The entrance 22 of the concentrator 24 is positioned near the entrance of the flame detector 200. The concentrator 24 of the present flame detector 200 has the same features as the concentrator as described with reference to FIGS. 2 to 4b. In some examples, the entrance 22 of the concentrator 24 may be in the same plane as the entrance window 206. In the present example, only the side of one concentrator is shown. More than one concentrator 24 may be positioned next to each other within the flame detector 200. At the exit of the concentrator 24 there is a detecting area 40 which comprises pyroelectric detectors (not shown) and a printed circuit board (PCB) 52. The PCB is connected to cables or PCB connectors (not shown) which send electrical signals to a main PCB. The main PCB contains a microcontroller and is connected to an external interface. Cables for power and/or to device which may provide a status is connected to the main PCB board through holes 221 in the rear of the flame detector 200. The cables are connected to the main PCB in an electrical component area 208. The cables may be connected to a device including an alarm unit which sounds an alarm when a fire is detected. In the present example, there is a USB port 214 for connecting with an external source, for example a computer, laptop or tablet.

At the entrance window 206 of the flame detector 200, there is a small reflector 210 used for testing the detector. The flame detector 200 comprises an internal light-emitter (not shown) which emits light to the reflector 210. The reflector 210 reflects the light to a further auxiliary pyroelectric detector(s) (not shown). The auxiliary detector(s) are coupled to a separate second printed circuit board (PCB) 212. The second PCB 212 is connected to cables or PCB connectors (not shown) which send electrical signals to the main PCB.

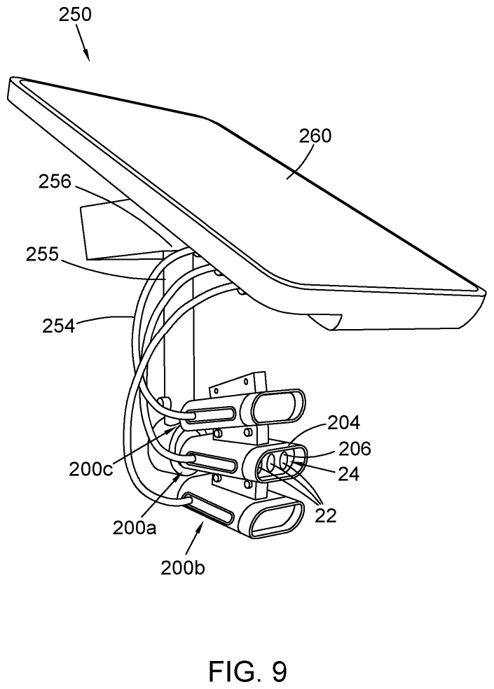

FIG. 9 shows an example perspective view of a flame detector system connected to a solar panel 260 as mounted on a pylon. The flame detector system comprises three separate flame detectors 200a, 200b, 200c in accordance with FIG. 2 to FIG. 4b, comprising three optical concentrators 24 with their entrance 22 at or near the window 206 of each flame detector. The flame detectors 200a 200b, 200c have a front cover 204 which protects the window 206 of the flame detector 200a, 200b, 200c against external influence, such as rain or dust. Above and below the flame detector 200a are further flame detectors 200b, 200c used collaboratively to increase the FOV in the vertical axis. The different flame detectors 200a, 200b, 200c are aligned such that their entrances are pointing at an angle away from the viewing axis of each other. In other examples, one flame detector 200b, 200c, may be replaced by an optical camera. The flame detectors 200a, 200b, 200c are mounted on a pylon (not shown) via an arm 255 and mounting plate 256. The flame detectors 200a, 200b, 200c are connected to a solar panel 260 via a cable 254.

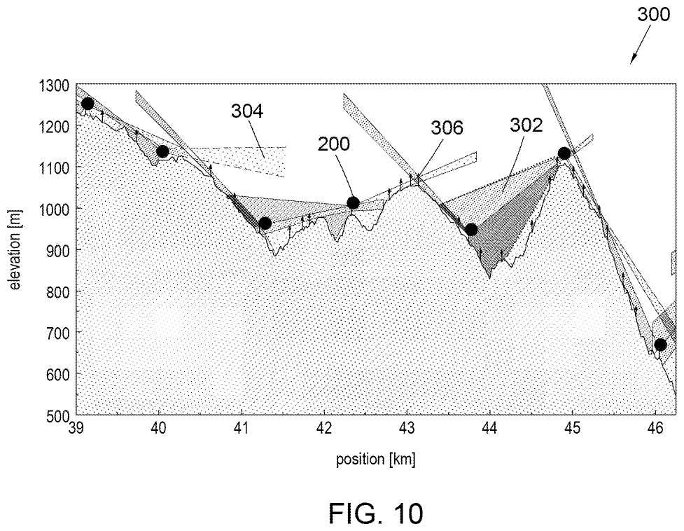

FIG. 10 shows a plot 300 of the geographical location of flame detectors 200 for example along a power line. The geographical plot 300 shows the position of typical pylons 306 and the positon of flame detectors 200 of FIG. 9 installed along a power line. The plot shows the distance, in kilometres, of the power line along the x-axis and the elevation, in meters, of the power line along the y-axis. The area within the dotted lines 302 shows an example of the field of view of the flame detectors 200 in one direction, for example the backward FOV. The area within the dashed lines 304 shows an example of the field of view of the flame detector 200 in another direction, for example the forward FOV.

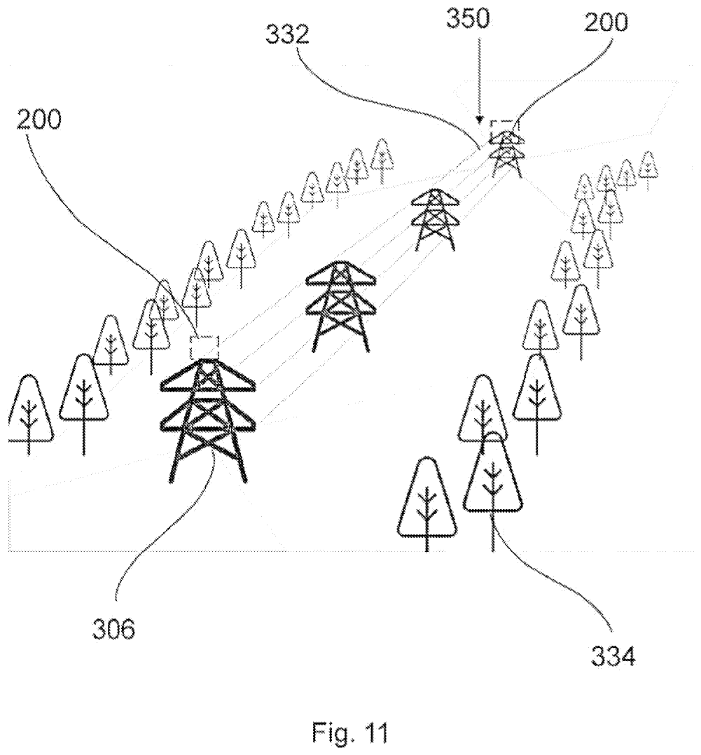

FIG. 11 shows a perspective view of an example power line 350 having a plurality of electrical pylons 306 on some of which the flame detectors 200 are installed. The power lines 350 would be in or near a forest 334. In the present example, the flame detector 200 is positioned on the top of the pylon 306. In other examples, the flame detector 200 may be positioned elsewhere, for example on a side arm of the pylon 306.

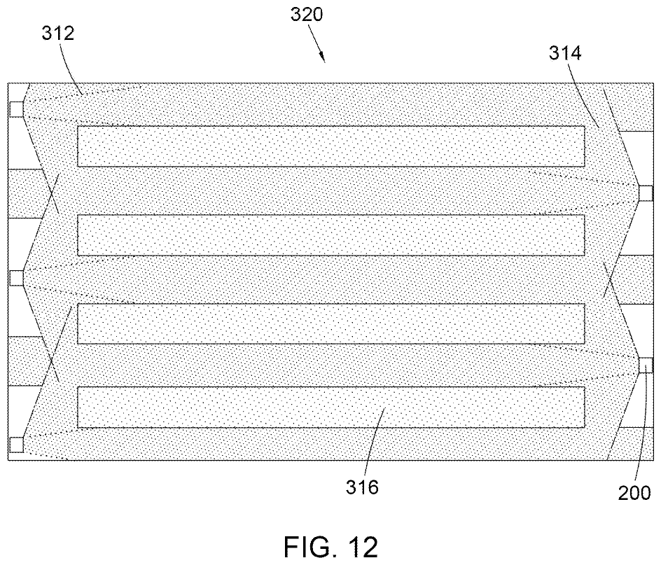

FIG. 12 shows a plan view of a warehouse 320 with a plurality of flame detectors 200 in accordance with the flame detector of FIG. 6 or 7. The warehouse 320 has shelves 316, and the flame detectors 200 are installed on the walls of the warehouse, such that the entrance window 206 of the flame detector 200 is directed towards and is viewing the corridor between the shelves 316. The flame detectors 200 may be mounted high on walls of the warehouse 320. The flame detectors 200 comprise a plurality of pyroelectric detectors and a plurality of optical concentrators in accordance with FIGS. 2 to 4b, which provide a long viewing range along the corridor between the shelves 316, as illustrated by dots 312. The flame detectors 200 may also comprise one or more auxiliary pyroelectric detectors that are not connected to an optical concentrator, or are coupled to an optical concentrator which allow a larger field of view than the other pyroelectric detectors, as illustrated by dashed lines 314.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The flame detector may comprise one or more auxiliary pyroelectric detectors. The auxiliary pyroelectric detectors may have the same components and features of the pyroelectric detectors of the first aspect of the present disclosure. There may be an auxiliary detector which is configured to detect human movement. There may be (for example two) additional auxiliary pyroelectric detectors which are arranged without any further optics. The auxiliary detectors may be used to detect non-fire signals that may cause a false alarm, for example signals from sources not covered by the detectors with further optics, especially so at short-ranges. The flame detector may then reject the signal before alarming the user. The auxiliary detectors may have similar dimensions to those of the main pyroelectric detectors.

In other examples, there may be an auxiliary detector without a concentrator for every one of the three main pyroelectric detectors with optics. Advantageously, in addition to the benefits of the auxiliary detectors as mentioned above, this may reduce the likelihood of a blind-spot at short ranges. The set of auxiliary detectors may form an auxiliary flame detection system, for example an IR3 flame detection system, with a larger FOV but a smaller range than the flame detector of the first aspect of the present disclosure. Additionally the auxiliary detectors may be used in combination with a light-emitter as part of the flame detection device or an attachment to it which may be used for testing methods without obscuring part of the FOV of the main detectors. For example, the transmission of the window and the function of the microcontroller and algorithms may be tested by providing a testing light signal (whilst suppressing the fire alarm that would otherwise be triggered by the test signal). Alternatively, a test light signal that is modulated at a different frequency (not classified as a flame flickering frequency) may be used, which would not require the suppression of the alarm during testing. This signal could then be extracted separately from the result of the Fast Fourier Transform.

In other examples, the filters may be located in front of the non-imaging optical concentrators, or may be located within the non-imaging optical concentrators. In other examples, one or more of the pyroelectric detectors may be replaced by a semiconductor based light detector, for example a photodetector.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A flame detector comprising:
a plurality of detectors;
a plurality of filters;
a plurality of non-imaging optical concentrators having an entrance arranged to receive light incident on the flame detector and an exit arranged to deliver the light to a coupled detector; and
wherein a first of the plurality of filters transmits light of a first wavelength range to a first of the detectors, and a second of the plurality of filters transmits light of a second wavelength range to a second of the detectors, wherein the second wavelength range is different from the first wavelength range.

2. A flame detector according to claim 1, wherein the detectors are pyroelectric detectors.

3. A flame detector according to claim 2, wherein each detector has a receiving surface comprising a layer of pyroelectric material wherein the receiving surface of each of the plurality of pyroelectric detectors is outside of the coupled non-imaging optical concentrator and at least 100 μm from the exit of the coupled non-imaging optical concentrator.

4. A flame detector according to claim 1, wherein the filters are positioned between the exits of the non-imaging optical concentrators and the detectors.

5. A flame detector according to claim 1, wherein the filters are positioned in front of the entrances of the non-imaging optical concentrators.

6. A flame detector according to claim 1, wherein the filters are positioned inside the non-imaging optical concentrators.

7. A flame detector according to claim 1, wherein the first filter blocks light with wavelengths not in the first wavelength range, and the second filter blocks light with wavelengths not in the second wavelength range.

8. A flame detector according to claim 1, wherein the first wavelength range in the range of 4.1 to 4.8 μm, and the second wavelength range is either wholly above or below the wavelength range of the first filter.

9. (Canceled)

10. A flame detector according to claim 1, wherein at least one non-imaging optical concentrator has a rectangular cross-section.

11-12. (Canceled)

13. A flame detector according to claim 3, wherein a distance between the pyroelectric receiving surface of each of the pyroelectric detectors and the exit of the coupled non-imaging optical concentrators is at least 150 μm.

14. (Canceled)

15. A flame detector according to claim 1, wherein the plurality of pyroelectric detectors form a triple-channel infrared detector.

16. A flame detector according to claim 1, wherein the plurality of detectors comprises three independent detectors.

17. A flame detector according to claim 1, comprising three non-imaging optical concentrators arranged such that the entrances of the three concentrators are contained within a first plane and the exits of the three concentrators are contained within a second plane, different from the first plane, and wherein each non-imaging optical concentrator is coupled to a different one of the plurality of detectors.

18-19. (Canceled)

20. A flame detector according to claim 1, wherein the detectors comprise a casing, the casing comprises an entrance window which is coupled to the exit of a non-imaging optical concentrator.

21. A flame detector according to claim 20, wherein the entrance window comprises one of the plurality of filters.

22-24. (Canceled)

25. A flame detector according to claim 1, comprising at least one auxiliary pyroelectric detector which is not coupled to a non-imaging optical concentrator but is configured to directly receive the light incident on the flame detector.

26. A flame detector according to claim 1, comprising at least one auxiliary pyroelectric detector which is coupled to at least one non-imaging optical concentrator having a larger field of view than the other plurality of non-optical concentrators.

27. A flame detector according to claim 25, wherein the auxiliary pyroelectric detector is configured to receive light via one of the plurality of filters configured to transmit light of a wavelength range corresponding to human and/or animal movement.

28. A flame detector according to claim 1, wherein the plurality of detectors comprise a semiconductor material.

29-31. (Canceled)

32. A method of detecting a fire using the flame detector according to claim 1, comprising the steps of:
a) collecting light over a pre-determined time interval;
b) converting the collected light into an electrical signal;
c) providing a calculated value for the light collected at each detector;
d) comparing differences of the calculated values with reference values;
e) using the comparisons to classify the signal as indicating or not indicating the presence of a fire.
